(19) United States
(12) Patent Application Publication
(10) Pub. No.: US 2018/0070043 A1
(43) Pub. Date: Mar. 8, 2018

(54) DISPLAY APPARATUS AND CONTROLLING METHOD THEREOF

(71) Applicant: SAMSUNG ELECTRONICS CO., LTD., Suwon-si (KR)

(72) Inventors: Jung-geun KIM, Suwon-si (KR); Chang-seog KO, Hwaseong-si (KR); Seok-hyun KIM, Suwon-si (KR)

(21) Appl. No.: 15/475,226

(22) Filed: Mar. 31, 2017

(30) Foreign Application Priority Data
Sep. 8, 2016 (KR) 10-2016-0115866

(51) Int. Cl. H04N 5/44; G11B 27/00; G06F 3/0482; H04N 13/04

(52) U.S. Cl. CPC H04N 5/4403; G11B 27/005; G06F 3/0488; H04N 13/045; H04N 13/0497; G06F 3/0482

(57) ABSTRACT

A display apparatus is provided. The display apparatus includes a display configured to display an image corresponding to a first view point in a panorama image at a predetermined first reproduction speed, an input unit comprising circuitry configured to receive a user interaction for moving a display view point of the panorama image, and a processor configured to control the display to display an image of a view point corresponding to the received user interaction by changing the reproduction speed of the panorama image to a second reproduction speed.

### CROSS-REFERENCE TO RELATED APPLICATION

This application is based on and claims priority under 35 U.S.C. §119 to Korean Patent Application No. 10-2016-0115866, filed on Sep. 8, 2016 in the Korean Intellectual Property Office, the disclosure of which is incorporated by reference herein in its entirety.

### BACKGROUND

### 1. Field

The present disclosure relates generally to a display apparatus and a controlling method thereof, and for example, to a display apparatus which allows a user to appreciate and control a panorama image and a controlling method thereof.

### 2. Description of Related Art

Due to the development of electronic technology, various types of electronic products have been developed and popularized. In particular, various photographing apparatuses such as a mobile phone, a notebook PC, and a PDA have been widely used in most ordinary households.

As the use of photographing apparatuses has increased, the user needs for more diverse functions have also increased. As a result, the effort of each manufacturer to meet user needs has increased, and new products having new functions that were not available in the past have appeared.

Recently, a photographing apparatus having a function of generating a panorama image by using an image photographed at a plurality of viewpoints has been developed. Such panorama images were generally viewed by moving the view point through a professional VR (virtual reality) device or a mobile phone.

However, when a panorama image is reproduced in a device having a fixed screen area such as a TV, only a partial view of the panorama image is displayed on the screen and thus, it is insufficient to appreciate the panorama image providing a wide view.

### SUMMARY

An aspect of various example embodiments relates to a display apparatus capable of controlling a panorama image based on a user interaction and a controlling method thereof.

According to an example embodiment, a display apparatus is provided, the display apparatus including a display configured to display an image corresponding to a first view point in a panorama image at a predetermined first reproduction speed, an input unit comprising receiver circuitry configured to receive an input user interaction for moving a display view point of the panorama image, and a processor configured to control the display to display an image of a view point corresponding to the received input user interaction by converting the reproduction speed of the panorama image to a second reproduction speed.

The processor, in response to the user interaction being completed, may control the display to display the image of the second view point which is currently displayed at the first reproduction speed.

The processor, in response to the user interaction being completed, may control the display to display a frame at the first reproduction speed from a frame of the panorama image immediately before conversion to the second reproduction speed.

The second reproduction speed may be one of a pause and a reproduction speed which is slower than the first reproduction speed.

The processor may control the display to display the panorama image at a second reproduction speed corresponding to a type of the input user interaction.

The processor, in response to a reproduction speed of the panorama image being converted, may control the display to display information on converted reproduction speed.

The processor, in response to receiving the user interaction input, may control the display to display a menu for converting a reproduction state of the panorama image.

The apparatus may further include an audio output unit comprising audio output circuitry configured to output an audio signal corresponding to the panorama image, and the processor, in response to a reproduction speed of the panorama image being converted, may control the audio output unit to output a predetermined sound or may control the audio output unit to output an audio signal corresponding to the converted reproduction speed.

The processor may control the display to display UI information corresponding to a view point which is currently displayed.

The panorama image may be a panorama image having a view of 360°.

According to an example embodiment, a method of controlling a display apparatus is provided, the method including displaying an image corresponding to a first view point in a panorama image at a predetermined first reproduction speed, receiving an input user interaction for moving a display view point of the panorama image, and displaying an image of a view point corresponding to the input user interaction by converting the reproduction speed of the panorama image to a second reproduction speed.

The method may further include, in response to the user interaction being completed, displaying the image of the second view point which is currently displayed at the first reproduction speed.

The method may further include, in response to the user interaction being completed, displaying a frame at the first reproduction speed from a frame of the panorama image immediately before conversion to the second reproduction speed.

The second reproduction speed may be one of a pause and a reproduction speed which is slower than the first reproduction speed.

The displaying an image of a view point corresponding to the input user interaction may include displaying the panorama image at a second reproduction speed corresponding to a type of the input user interaction.

The method may further include, in response to a reproduction speed of the panorama image being converted, displaying information on converted reproduction speed.

The method may further include, in response to the user interaction being input, displaying a menu for converting a reproduction state of the panorama image.

The method may further include, in response to a reproduction speed of the panorama image being converted, outputting a predetermined sound or outputting an audio signal corresponding to the converted reproduction speed.

The method may further include displaying UI information corresponding to a view point which is currently displayed.

According to an example embodiment, a non-transitory computer readable recording medium is provided, including a program for executing a controlling method of a display apparatus, which when executed by a processor, causes the display apparatus to perform operations including displaying an image corresponding to a first view point in a panorama image at a predetermined first reproduction speed, receiving an input user interaction for moving a display view point of the panorama image, and displaying an image of a view point corresponding to the received input user interaction by converting the reproduction speed of the panorama image to a second reproduction speed.

### BRIEF DESCRIPTION OF THE DRAWINGS

The above and/or other aspects, features and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example display system according to an example embodiment;

FIG. 2 is a block diagram illustrating an example configuration of a display apparatus according to an example embodiment;

FIG. 3 is a block diagram illustrating an example configuration of a display apparatus according to an example embodiment;

FIGS. 4, 5, 6, 7 and 8 are diagrams illustrating various examples of controlling reproduction of a panorama image which is displayed in a display apparatus based on a user interaction according to various example embodiments; and

FIG. 9 is a flowchart illustrating an example method of controlling a display apparatus according to an example embodiment.

### DETAILED DESCRIPTION

Hereinafter, the terms used in example embodiments will be briefly explained, and example embodiments will be described in greater detail with reference to the accompanying drawings.

Although the terms used in the example embodiments are general terms, which are widely used in the present time considering the functions in the present disclosure, the terms may be changed depending on an intention of a person skilled in the art, a precedent, introduction of new technology, etc. In addition, in a special case, terms selected arbitrarily may be used. In this case, the meaning of the terms will be explained in detail in the corresponding detailed descriptions. Accordingly, the terms used in the description should not necessarily be construed as simple names of the terms, but be defined based on meanings of the terms and overall contents of the present disclosure.

The example embodiments may vary, and may be provided in different example embodiments. Various example embodiments will be described with reference to accompanying drawings. However, this is not intended to limit the scope to an example embodiment, and therefore, it should be understood that all the modifications, equivalents or substitutes included under the spirit and technical scope are encompassed. While describing example embodiments, if it is determined that the specific description regarding a known technology might obscure the gist of the disclosure, the specific description is omitted.

In the present disclosure, terms such as first and second, and the like, may be used to describe various elements, but should not be limited thereto. Such terms should be used only to distinguish one entity from another entity.

It is to be understood that the singular forms include plural referents unless the context clearly dictates otherwise. The terms, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof.

In an example embodiment, ‘a module’ or ‘a unit’ performs at least one function or operation, and may be realized as hardware, software, or combination thereof. In addition, a plurality of ‘modules’ or ‘units’ may be integrated into at least one module and may be integrated into at least one module to form at least one processor except for ‘modules’ or ‘units’ that should be realized as specific hardware.

The example embodiments of the disclosure will be described in greater detail below in a manner that will be understood by one of ordinary skill in the art. However, example embodiments may be realized in a variety of different configurations, and not limited to descriptions provided herein. Further, those that are irrelevant with the description may be omitted so as to describe example embodiments more clearly, and similar drawing reference numerals are used for the similar elements throughout the description.

Hereinafter, the present disclosure will be explained in greater detail with reference to the drawings.

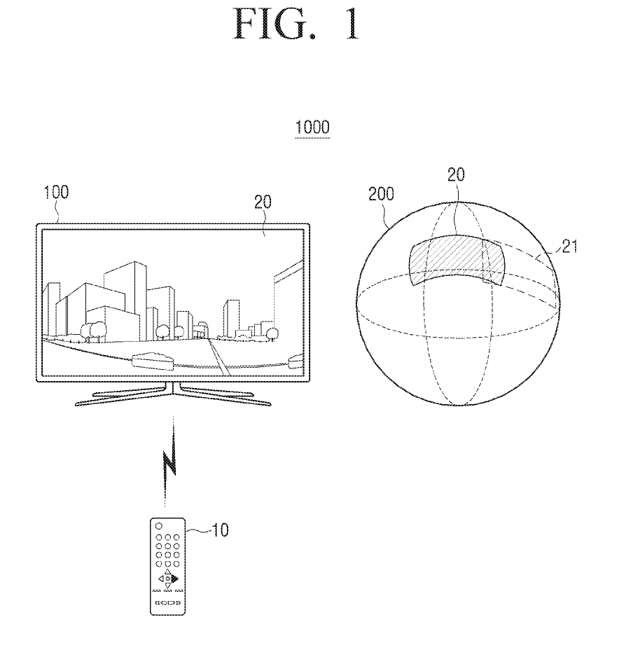

FIG. 1 is a diagram illustrating an example display system according to an example embodiment of the present disclosure.

Referring to FIG. 1, a display system 1000 includes a display apparatus 100 and an electronic apparatus (which may be realized in many and various forms as discussed in greater detail below) 10 capable of controlling the display apparatus 100. The display apparatus 100 and the electronic apparatus 10 can be connected to each other to exchange control signals, images, and the like.

The right figure of the display system 1000 illustrated in FIG. 1 is illustrated for the purpose of helping understanding of a panorama image (spherical image) having a 360-degree view, and illustrates an image 20 at the first view point and an image 21 at the second view point which is adjacent to the image 20 at the first view point in the panorama image 200. The display apparatus 100 may move the view point in such a manner as to rotate the panorama image 200 to display the image 21 at the second view point in accordance with the user interaction input during displaying the image 20 at the first view point.

The display apparatus 100 is an apparatus for displaying images, and may include a smart phone, a TV, a tablet PC, a notebook PC, a desktop PC, a projector, and the like, but is not limited thereto.

The display apparatus 100 may receive a control signal based on a user manipulation performed in the electronic apparatus 10 and may perform an operation corresponding to the control signal. According to an example embodiment, the display apparatus 100 may display a panorama image, and may move the view point of the panorama image according to a control signal received from the electronic apparatus 10.

The panorama image is an image having a plurality of viewpoints, for example, an image generated by combining a plurality of images photographed while moving one camera or a plurality of images photographed at different viewpoints in the same space using a plurality of cameras, or an image captured by one camera having a wide angle of view. In addition, the panorama image is not limited to an image captured by a camera. For example, the contents which are artificially generated, such as a game image, may correspond to a panorama image. Meanwhile, an image is a concept that may include both a still image and a moving image.

Among the panorama images, there is a panorama image having a 360-degree view. The panorama image having a 360-degree view may refer, for example, to an image of which start and end are the same, and can be called various names such as a spherical image and an omnidirectional image. Particularly, according to an example embodiment, in the case where a user views a panorama image having a 360-degree view through the display apparatus 100, when an image at another viewpoint is displayed according to the user interaction, the user may enjoy desired scenes without missing any.

The electronic apparatus 10 may be an apparatus having a manipulation unit for controlling an image displayed on the display apparatus 100 and may be implemented as various electronic apparatuses such as a smart phone, a tablet PC, a notebook PC, a desktop PC, a remote controller, a wearable device, and the like, but is not limited thereto. The electronic apparatus 10 includes at least one of various devices such as a touch screen, a physical button, a keyboard, a mouse, a motion recognition sensor, a pressure recognition sensor, and the like capable of receiving a user manipulation for controlling an image displayed on the display apparatus 100.

Although in the above example embodiment, an image displayed on the display apparatus 100 is controlled by using the separate electronic apparatus 10, a button provided on the display apparatus 100, the image may be controlled by inputting a user manipulation by using a button, a touch screen or sensor provided on the display apparatus 100 itself.

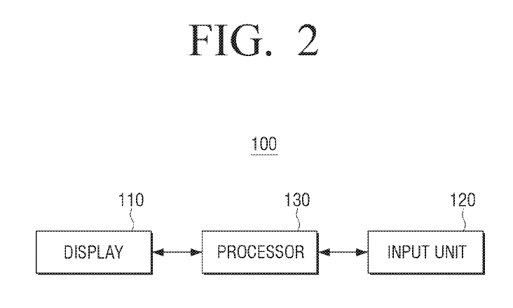

Hereinafter, the configuration of the display apparatus 100 according to an example embodiment will be described in greater detail with reference to FIG. 2.

FIG. 2 is a block diagram illustrating an example configuration of a display apparatus according to an example embodiment of the present disclosure.

Referring to FIG. 2 the display apparatus includes a display 110, an input unit (e.g., including circuitry for receiving an input) 120 and a processor (e.g., including processing circuitry) 130.

The display apparatus 100 is an apparatus for displaying an image, and may be, for example, a TV, a tablet PC, a notebook PC, a desktop PC, a projector, or the like, but is not limited thereto.

The display 110 is configured to display various screens. The display 110 may be a liquid crystal display (LCD), and may be a cathode ray tube (CRT), a plasma display panel (PDP), an organic light emitting diode (OLED), transparent OLED (TOLED), or the like, but is not limited thereto. Also, the display 110 may be implemented as a touch screen capable of sensing a user's touch manipulation.

Specifically, the display 110 may display an image corresponding to a view point in a panorama image at a predetermined first reproduction speed. Here, the first reproduction speed may be 1× the normal reproduction speed of the image.

The input unit 120 may include various input circuitry configured to receive a manipulation command (e.g., from a user).

The input unit 120 may be implemented as various input circuitry, such as, for example, and without limitation, a button, a pointing device, a mouse, a keyboard, a voice recognition device, a motion recognition device, a touch panel. In addition, the input unit 120 may include a remote control signal receiving unit including various circuitry for receiving a control signal corresponding to a user manipulation from a remote controller for controlling the display apparatus 100. The remote control signal receiving unit may include, for example, a photodiode for receiving an IR signal generated in a remote control device.

The input unit 120 may select an area to be displayed in the panorama image. More specifically, the input unit 120 may receive a user interaction for moving the display view point of the panorama image.

The processor 130 may include various processing circuitry for controlling the overall operations of the display apparatus 100. The processor 130 may include various circuitry, such as, for example, and without limitation, a CPU, a RAM, a ROM, and a system bus. In the above description, the processor 130 includes only one CPU, but may be implemented by a plurality of CPUs (DSP, MPU, etc.) at the time of implementation. The processor 130 may be implemented as a dedicated processor, a MICOM (MICRO COMPUTER), an ASIC (application specific integrated circuit), or the like.

When a user interaction is input via the input unit 120, the processor 130 may control the display 110 to display an image at a time corresponding to the input user interaction. At this time, the processor 130 may convert the reproduction speed of the panorama image to a second reproduction speed and control the display 110 to display an image at a time corresponding to the user interaction.

Specifically, if a user interaction for displaying an image corresponding to the second view point in the panorama image is sensed by the input unit 120 while the image corresponding to the first view point in the panorama image is being displayed on the display 110, the processor 130 may control the display 110 to convert the reproduction speed of the image and display the image while moving the display view point of the panorama image from the first view point to the second view point.

At this time, the converted reproduction speed may be slower than the predetermined first reproduction speed or may be zero. Here, when the reproduction speed is 0, the image may be temporarily stopped. Meanwhile, the converted reproduction speed may be faster than the predetermined first reproduction speed.

For example, when the user interaction is sensed, the processor 130 may control the display 110 to temporarily stop the panorama image while moving the display view point from the first view point to the second view point in the panorama image, or adjust the reproduction speed of the panorama image slowly or rapidly and display the image.

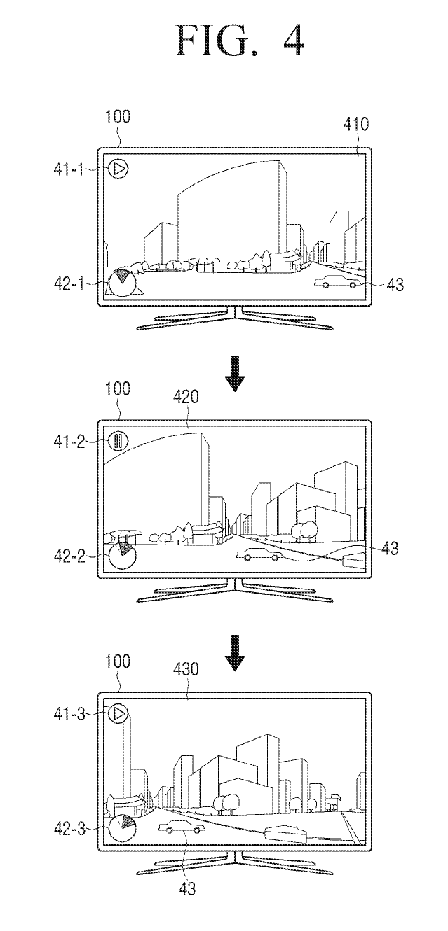

Meanwhile, when the reproduction speed of the panorama image is converted as a user interaction is sensed, the processor 130 may control the display 110 to display information on the converted reproduction speed information. Specifically, when the panorama image is displayed at a normal reproduction speed, the processor 130 may control the display 110 to display an object representing ‘reproduction’. When the view point moves while the panorama image is temporarily stopped as a user interaction is detected, the display 110 may be controlled to display an object representing the reproduction speed converted when the reproduction speed is changed. At this time, the object representing ‘pause’, and when the reproduction speed is converted, the display 110 may be controlled to display an object representing the converted reproduction time. At this time, the object indicating ‘reproduction’ may be continuously displayed while the panorama image is displayed, or may be displayed only when the user interaction is sensed. Various example embodiments for converting the reproduction speed of a panorama image according to a user interaction will be described in greater detail below with reference to FIGS. 4 to 7.

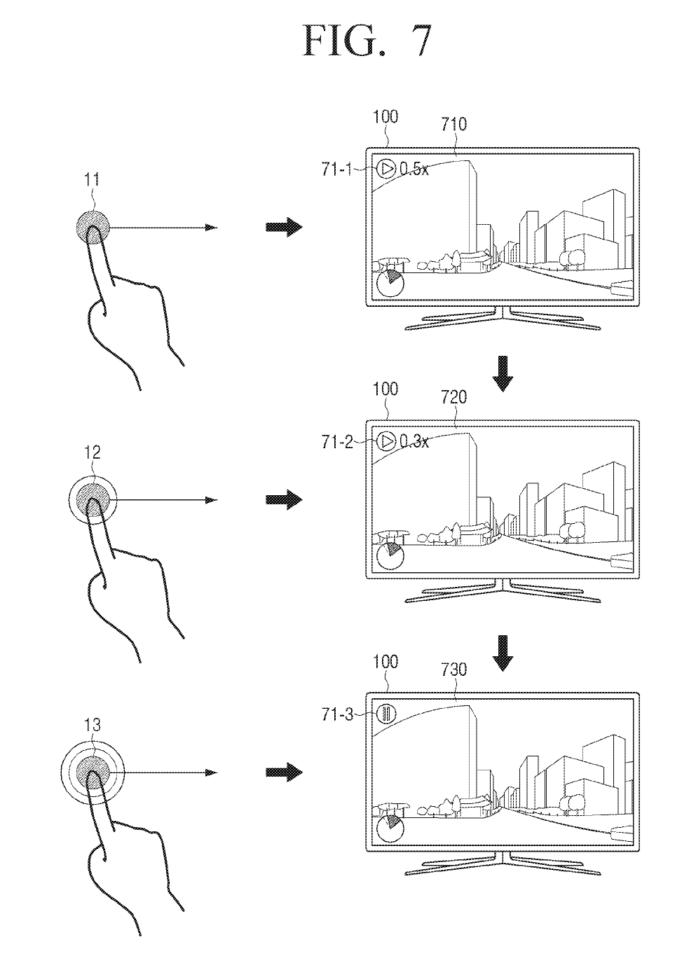

Meanwhile, the processor 130 may display a panorama image at the second reproduction speed corresponding to the type of a user interaction. Specifically, the processor 130 may control the panorama image at a reproduction speed corresponding to each user interaction. For example, when a user interaction is input through a remote controller which is an external apparatus, the panorama image may be displayed at different reproduction speeds according to the time during which a button on the remote controller is pressed, and when a user interaction is input through the display 110, the panorama image may be displayed at different reproduction speeds according to the touch time or strength, which will be described in greater detail below with reference to FIG. 7.

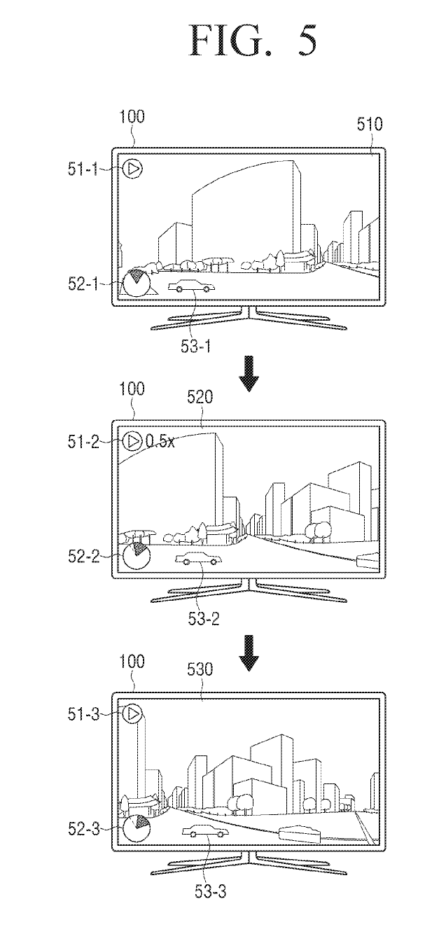

Meanwhile, when the user interaction is terminated, the processor 130 may control the display 110 to display the image of the second viewpoint, which is currently displayed at the first reproduction speed. Specifically, if a user interaction is not sensed for a predetermined time after the user interaction is sensed, the processor 130 may determine that the user interaction is terminated and convert the reproduction speed of the panorama image and display the panorama image again at the first reproduction speed which is the original speed, which will be described in greater detail below with reference to FIGS. 4 and 5.

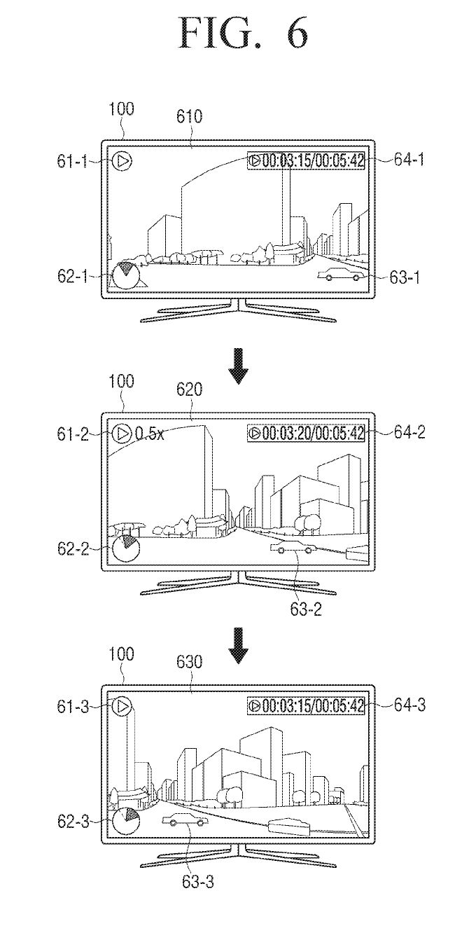

Meanwhile, when the user interaction is terminated, the processor 130 may control the display 110 to display a frame of the panorama image at the first reproduction speed from the frame immediately before conversion to the second reproduction speed. Specifically, the processor 130 may convert the reproduction speed of the panorama image and display the image while the user interaction is sensed and the display view point is converted from the first view point to the second view point, and when the user interaction is terminated, the processor 130 may control the display 110 to display a frame of the panorama image at the first reproduction speed from the frame immediately before conversion of the reproduction speed by rewinding an image corresponding to the second view point in the panorama image, which will be described in greater detail below with reference to FIG. 6.

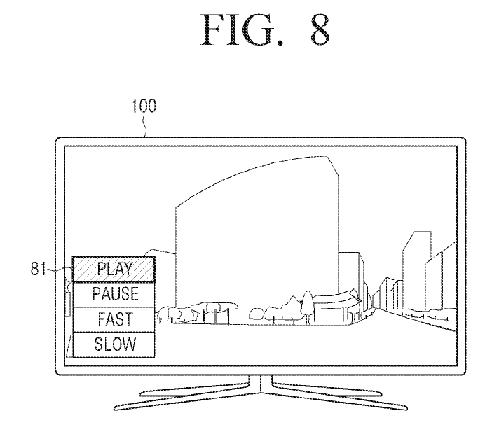

Meanwhile, when a user interaction is input through the input unit 120, the processor 130 may control the display 110 to display a menu for converting the reproduction state of the panorama image. Specifically, the processor 130 may control the display 110 to display a menu for converting the reproduction speed of the panorama image in a pop-up form according to a user interaction. An example embodiment in which a menu for converting the reproduction state by a user according to a user interaction will be described in greater detail below with reference to FIG. 8.

Meanwhile, the processor 130 may control the display 110 to display UI information corresponding to the view point of the panorama image, which is currently displayed. Specifically, the processor 130 may control the display 110 to display UI information corresponding to the view point which is currently displayed in the panorama image which is a 360-degree view.

Meanwhile, even if the same user interaction is input, the processor 130 may perform different controls according to the type of the displayed panorama image. For example, if the displayed panorama image is a real-time broadcast content provided by a broadcasting station, the processor 130 may move the display view point from the first view point to the second view point while maintaining the reproduction speed even if a user interaction is sensed. Meanwhile, if the displayed panorama image is the content previously stored in the display apparatus 100 or the content other than the real-time broadcast content received from an external server, the processor 130 may control the panorama image by converting the reproduction speed according to a user interaction.

According to the above-described various example embodiments, it is possible to control the panorama image in various ways according to a user interaction. Particularly, by controlling the pause or reproduction speed of the image while moving the display view point, a user may enjoy desired scenes of the panorama image without missing any.

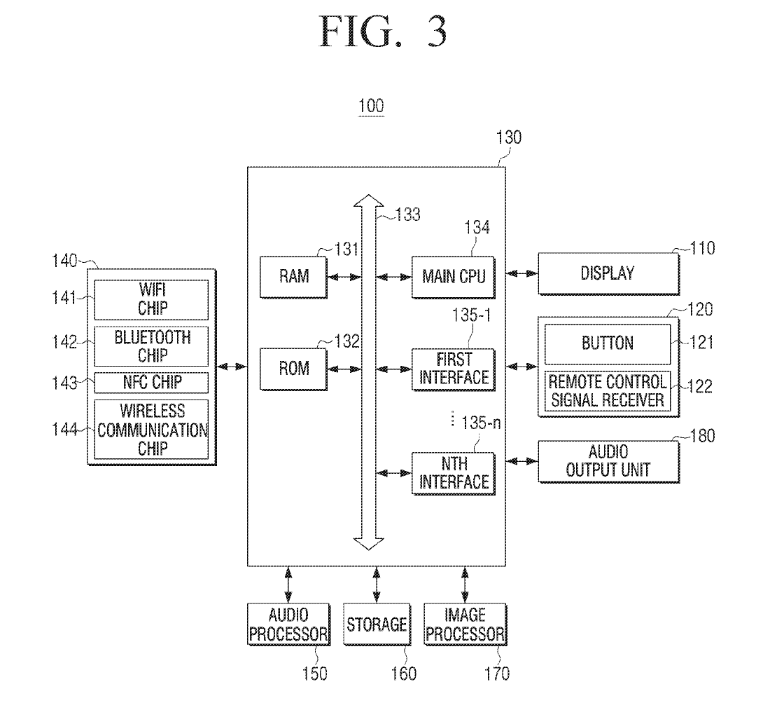

FIG. 3 is a block diagram illustrating an example configuration of a display apparatus according to an example embodiment of the present disclosure.

Referring to FIG. 3, the display apparatus 100 includes the display 110, the input unit (e.g., including input circuitry) 120, the processor (e.g., including processing circuitry) 130, a communicator (e.g., including communication circuitry) 140, a storage 160, an audio processor 150, an image processor 170, and an audio output unit (e.g., including audio output circuitry) 180.

The display 110 may be implemented in various forms such as an LCD, a CRT, a PDP, an OLED, a TOLED, a thin film electroluminescent (TFE), or the like, and in some cases in the form of a touch screen, but is not limited thereto.

The communicator 140 may include various communication circuitry and is configured to communicate with various kinds of external devices in various communication methods. The communicator 140 may include various communication chips/circuitry, such as, for example, and without limitation, a Wi-Fi chip 141, a Bluetooth chip 142, a Near Field Communication (NFC) chip 143, a wireless communication chip 144, and the like.

The WiFi chip 141, the Bluetooth chip 142, and the NFC chip 143 may perform communication using a WiFi method, a Bluetooth method, and an NFC method, respectively. The NFC chip 143 may refer to a chip that operates in a NFC manner using a frequency band of 13.56 MHz among various RF-ID frequency bands such as 135 kHz, 13.56 MHz, 433 MHz, 860 to 960 MHz, 2.45 GHz, and the like. When the WiFi chip 141 or the Bluetooth chip 142 is used, a variety of connection information such as an SSID and a session key may be exchanged first, and communication may be established using the connection information, and then a variety of information may be exchanged. The wireless communication chip 144 refers to a chip which performs communication in accordance with various communication standards such as IEEE, ZigBee, 3rd generation (3G), 3rd generation partnership project (3GPP), and long term evolution (LTE) or the like.

The storage 160 may be implemented to be non-volatile memory, volatile memory, flash memory, hard disk drive (HDD) or solid state drive (SSD). The storage 160 may be accessed by the processor 130 and may read/record/correct/delete/update data under the control of the processor 130. Meanwhile, the storage 160 may be realized as a recording medium within the electronic apparatus 100 or as an external storage medium, such as a USB memory, a web server via network, etc.

The storage 160 may store programs such as O/S and various applications, and various data such as user setting data, data generated in the course of application execution, multimedia contents, and the like.

The audio processor 150 performs processing with respect to audio data. The audio processor 150 may perform various processing such as decoding, amplification, noise filtering, etc. with respect to audio data. If a panorama image including an audio signal is reproduced, the processor 150 may control the audio processor 150 to output the audio signal. The audio signal is provided to a speaker 180 and output through the speaker 180.

The audio output unit 180 may include various circuitry that outputs not only various audio data but also various alarm sounds or voice messages which are processed by the audio processor 150. Specifically, the audio output unit 180 may output an audio signal corresponding to the panorama image.

The image processor 170 may include various circuitry to form a screen displayed on the display 110 as described above. The image processor 170 may include various elements such as a codec, a parser, a scaler, a noise filter, a frame rate conversion module, etc., for performing encoding or decoding on video data.

The input unit 120 may include various input circuitry and is configured to receive a user command. The input unit 120 may include various input circuitry, such as, for example, and without limitation, a button 121 and a remote control signal receiver 122. The button 121 may be various types of buttons such as a mechanical button, a touchpad, a wheel, etc. formed on an arbitrary region such as a front portion, a lateral portion, and a bottom portion of an external surface of a main body of the display apparatus 100. The button 121 may be composed of one or a plurality of buttons. The operations of power turn-off, power turn-on, channel up, channel down, volume up, volume down, etc. may be performed through the button 121. A remote control signal receiver 183 receives a signal of the remote controller.

The processor 130 may include various processing circuitry and controls the overall operations of the display apparatus 100 using various programs stored in the storage 160.

The processor 130 includes RAM 131, ROM 132, a main CPU 134, a first to an n-th interface 135-1˜135-n and a bus 133. The RAM 131, the ROM 132, the main CPU 134, and the first to the n-th interface 135-1˜135-n may be connected to each other through the bus 133.

The first to the nth interface 135-1 to 135-n are connected to the above-described various elements. One of the interfaces may be a network interface which is connected with an external device via a network.

The main CPU 134 accesses the storage 160 and performs booting using the O/S stored on the storage 160. Then, the main CPU 134 performs various operations using various programs, contents, data, etc. stored on the storage 160.

The ROM 132 may store a set of commands and the like for system booting. When a command to turn on power is input and power is supplied, the main CPU 134 copies an operating system (O/S) stored on the storage 160 according to a command stored in the ROM 132 and executes the O/S to boot the system. When the booting is completed, the main CPU 134 copies various application programs stored in the storage 160 to RAM 131, and perform various operations by implementing the application programs copied to RAM 131.

Specifically, when the reproduction speed of the panorama image is changed as a user interaction is input, the processor 130 may control the audio output unit 180 to output an audio signal corresponding to the preset sound or the converted reproduction speed. For example, when the reproduction speed is changed according to a user interaction, the processor 130 may control the audio output unit 180 to output a preset sound while moving the display view point or control the audio output unit 180 to output an audio signal of an image corresponding to the converted reproduction speed.

In addition, although not shown in FIG. 3, the display apparatus 100 may further include an external input unit. The external input unit can receive an image (e.g., a panorama image and the like), audio (e.g., audio, music, etc.) and data (e.g., a reproduction command) from outside the display apparatus 100 under the control of the processor 130. The external input unit may include one of a High-Definition Multimedia Interface (HDMI) input port, a component input jack, a PC input port, and a USB input jack. The external input unit may include a combination of an HDMI input port, a component input jack, a PC input port, and a USB input jack.

FIGS. 4, 5, 6, 7 and 8 are diagrams illustrating various example embodiments where the reproduction of a panorama image displayed on a display apparatus is controlled based a user interaction.

Specifically, FIG. 4 is a diagram illustrating an example embodiment where the display apparatus 100 temporarily stops a panorama image and moves a view point according to a user interaction.

Referring to FIG. 4, the display apparatus 100 may display a first image 410 which is an image immediately after a user interaction is input, a second image 420 in which a display view point is shifted according to the user interaction and a third image 430 which is an image immediately after the user interaction is completed.

Specifically, the display apparatus 100 may display the first image 410 to the third image 430 sequentially while shifting the display view point from the first view point to the second view point in the panorama image according to the user direction. Here, the display apparatus 100 may stop the panorama image temporarily while shifting the display view point in the panorama image.

For example, the display apparatus 100 may display the first image 410 corresponding to the first view point in the panorama image. Here, the first image 410 may display a ‘reproduction’ object 41-1 representing the current reproduction state, and may also display UI information 42-1 corresponding to the currently displayed view point in the panorama image.

In this case, if a user interaction to move the display view point to the second view point is sensed, the display apparatus 100 may stop temporarily and display the image as shown in the second image 420 corresponding to one view point between the first view point and the second view point. Here, the second image 420 may display a ‘pause’ object 41/2 representing the reproduction state, and may also display UI information 42-2 corresponding to the current display view point in the panorama image. Here, the point displayed in the UI information 42-2 in the second image 420 may be a point which is shifted in the direction corresponding to movement of the display view point from the view point displayed in the UI information 42-1 in the first image 410.

Subsequently, if it is determined that the user interaction is stopped as the user interaction has not been sensed for a predetermined time, the display apparatus 100 may reproduce again the third image 430 corresponding to the second view point in the panorama image. Here, the third image 430 may display a ‘reproduction’ object 41-3 representing the reproduction state, and may also display UI information 42-3 corresponding to the currently displayed view point in the panorama image. Here, the point displayed in the UI information 42-3 in the third mage 430 may be a point which is shifted in the direction corresponding to movement of the display view point from the view point displayed in the UI information 42-2 in the second image 420.

The running vehicle 43 in the first image 410 to the third image 430 is illustrated to explain that the display view point is shifted in a state where the panorama image is temporarily stopped according to the user interaction. The spatial position of the vehicle 43 is maintained, and only the display view point is shifted in the panorama image.

Meanwhile, in the above description, the reproduction state of the panorama image is represented only by the objects 41-1 to 41-3. However, in actual implementation, the display apparatus 100 may output a predetermined sound irrelevant to the image through the audio output unit and provide feedback to inform that the view point is moving.

As described above, when a user interaction is input, the panorama image is paused and the display view point is moved. Thus, a user can enjoy various images of the same time zone in the panorama image without missing any.

Meanwhile, FIG. 5 is a diagram illustrating an example embodiment where the reproduction speed of a panorama image is converted and a view point is changed according to a user interaction.

Referring to FIG. 5, the display apparatus 100 may display a first image 510 which is an image immediately after a user interaction is input, a second image 520 in which a display view point is shifted according to the user interaction and a third image 530 which is an image immediately after the user interaction is completed.

Specifically, the display apparatus 100 may display the first image 510 to the third image 530 sequentially while shifting the display view point from the first view point to the second view point in the panorama image according to the user direction. Here, the display apparatus 100 may display the image by changing the reproduction speed of the panorama image while moving the display view point within the panorama image. Specifically, the panorama image can be displayed at a slower or faster reproduction speed than the normal first reproduction speed, e.g., 1× speed. Hereinafter, for the sake of convenience of explanation, it is explained that the display apparatus 100 displays the image at a reproduction speed that is slower than the first reproduction speed in accordance with the user interaction

The display apparatus 100 may display the first image 510 corresponding to the first view point in the panorama image. Here, the first image 510 may display a ‘reproduction’ object 51-1 representing the current reproduction state, and may also display UI information 52-1 corresponding to the currently displayed view point in the panorama image

In this case, if a user interaction to move the display view point to the second view point is sensed, the display apparatus 100 may display the panorama image at 0.5 times reproduction speed as illustrated in the second image 520 corresponding to a view point between the first time point and the second time point. Here, the ‘0.5×’ object 51-2, which is an object representing the reproduction state, may be displayed in the second image 520, and UI information 52-2 corresponding to the current display view time may be displayed in the panorama image. Here, the point displayed in the UI information 52-2 in the second image 520 may be a point which is shifted from the point displayed in the UI information 52-1 in the first image 510 in a direction corresponding to the movement of the display view point.

Subsequently, if it is determined that the user interaction is stopped as the user interaction has not been sensed for a predetermined time, the display apparatus 100 may reproduce the third image 530 corresponding to the second view point in the panorama image at the original reproduction speed of 1× speed. Here, the third image 530 may display a ‘reproduction’ object 41-3 representing that the image is being reproduced at the normal reproduction speed, and may also display UI information 52-3 corresponding to the currently displayed view point in the panorama image. Here, the point displayed in the UI information 52-3 in the third mage 530 may be a point which is shifted in the direction corresponding to movement of the display view point from the view point displayed in the UI information 52-2 in the second image 520.

The running vehicles 53-1 to 53-3 in the first image 510 to the third image 530 are illustrated to explain that the display view point is shifted in a state where the panorama image is displayed at a slower reproduction speed, and along with the movement of the display view point according to a user interaction, the spatial position of the vehicles 53-1 to 53-3 also moves in accordance with the running direction of the vehicles.

Meanwhile, in the above description, the reproduction state of the panorama image is represented only by the objects 51-1 to 51-3. However, in actual implementation, the display apparatus 100 may output a predetermined sound irrelevant to the image through the audio output unit and provide feedback to inform that the view point is moving.

As such, by changing the reproduction speed of the panorama image and moving the display view point as a user interaction is input, a user can enjoy various screens in the panorama image at a time zone close to the time of inputting the user interaction without missing any.

Meanwhile, FIG. 6 is a diagram illustrating an example embodiment in which when a user interaction ends, the display apparatus 100 reproduces again an image from the time when the user interaction is sensed.

Referring to FIG. 6, the display apparatus 100 may display a first image 610 which is an image immediately after a user interaction is input, a second image 620 in which a display view point is shifted according to the user interaction and a third image 630 which is an image immediately after the user interaction is completed.

Specifically, the display apparatus 100 may display the first image 610 to the third image 630 sequentially while shifting the display view point from the first view point to the second view point in the panorama image according to the user direction. Here, the display apparatus 100 may display an image by maintaining or changing the reproduction speed of the panorama image while moving the display view point within the panorama image. Hereinafter, for convenience of explanation, it is described that the reproduction speed is slower than the first reproduction speed in accordance with the user interaction.

The display apparatus 100 may display the first image 610 corresponding to the first viewpoint in the panorama image. In this case, the first image 610 may display a ‘reproduction’ object 61-1, which is an object indicating the current reproduction state, may be displayed on the first image 610, and may also UI information 62-1 corresponding to the currently displayed view point in the panorama image. In the first image 610, there is a running vehicle 63-1, and a reproduction time object 64-1 indicating the reproduction time of the panorama image can be displayed. Here, the first image 610 may be an image at 3 minutes and 15 seconds of the panorama image having a total reproduction time of 5 minutes and 42 seconds.

In this case, if a user interaction to move the display view point to the second time point is sensed, the display apparatus 100 may display the panorama image at the reproduction speed of 0.5 times as shown in the second image 620 corresponding to one view point between the first view point and the second view point. Here, the second image 620 may display a ‘0.5×’ object 61-2, which is an object representing the reproduction state, and may also display UI information 62-2 corresponding to the currently displayed view point in the panorama image. Here, the point displayed in the UI information 62-2 may be a point which moves in the direction corresponding to the movement of the display view point from the point displayed in UI information 62-1 in the first image 610. In this case, the second image 620 may be an image at 3 minutes and 30 seconds when the reproduction is performed for 5 seconds in the first image 610. Here, since the reproduction speed of the second image 620 is 0.5 times, the actual reproduction time from the first image 610 may be longer than 5 seconds.

Subsequently, as the display view point is shifted in a state in which the panorama image is displayed at a slow reproduction speed according to the user interaction, a vehicle 63-2 running in the second image 620 moves in the running direction of the vehicle. It can be seen that the reproduction of the panorama image is progressing due to a reproduction time object 64-2 displayed on the second image 620.

Subsequently, if it is determined that a user interaction is completed as the user interaction has not been sensed for a predetermined time, the display apparatus 100 displays the third image 630 corresponding to the second view point in the panoramic image at its original speed which is 1× speed. Here, the third image 630 which is displayed as the user interaction ends, may be the image rewound to the image when the user interaction is input. Specifically, when the user interaction ends, the display apparatus 100 may display the panorama image at a normal reproduction speed from the frame of the panorama image immediately before the speed of the panorama image is converted according to the user interaction. Here, the third image 630 may be an image when the user interaction is input in the panorama image, that is, when the reproduction time is 3 minutes and 15 seconds as in the case of the first image 610

Accordingly, a vehicle 63-3 running in the third image 630 is rewound in the direction opposite to the running direction, and the reproduction time displayed in a reproduction time object 64-3 can be returned to the time when the user interaction is input.

The third image 630 may display a ‘reproduction’ object 61-3, which is an object indicating that the image is being reproduced at a normal reproduction speed, and may also display UI information 62-3 corresponding to the currently displayed view point in the panorama image. Here, the point displayed in the UI information 62-3 in the third image 630 is a point which moves in the direction corresponding to the movement of the display view point from the point displayed in the UI information 62-2 in the second image 620.

Meanwhile, in the above description, the reproduction state of the panorama image is represented only by the objects 61-1 to 61-3. However, in actual implementation, the display apparatus 100 may output a predetermined sound irrelevant to the image through the audio output unit and provide feedback to inform that the view point is moving.

In the above description, the reproduction speed of the panorama image is converted and displayed while the display view point is shifted in the panorama image. However, in actual implementation, the display view point in the panorama image may be shifted while the reproduction speed is maintained at 1×.

As such, when the user interaction ends, the user can reproduce again the panorama image from the frame when the user interaction is input and thus, the user can enjoy various screens of a time zone which is the same as or similar to the time when the user interaction is input, without missing any.

Meanwhile, FIG. 7 is a diagram illustrating various example embodiments in which the reproduction speed of a panorama image is controlled in various ways according to various user interactions.

Referring to FIG. 7, the display apparatus 100 may control the reproduction speed of the panorama image according to the length of a user's touch interaction. Specifically, if the user performs dragging 11 in a direction during a first short touch state, the display apparatus 100 may display a panorama image 710 of which reproduction speed is converted to the speed of 0.5 times while the display view point is moved in the dragging direction. In addition, the display apparatus 100 may also display a ‘0.5×’ object 71-1 indicating that the panorama image is being reproduced at the speed of 0.5 times.

Meanwhile, if the user performs dragging 12 in a direction during a second touch which is longer than the first touch, the display apparatus 100 may display a panorama image 720 of which reproduction speed is converted to 0.3 times which is slower that the speed of 0.5 times while the display view point is moved in the dragging direction. In addition, the display apparatus 100 may also display a ‘0.3×’ object 71-2 indicating that the panorama image is being reproduced at the speed of 0.3 times.

Meanwhile, if the user performs dragging 13 in a direction during a third touch which is longer than the second touch, the display apparatus 100 may display a panorama image 730 in which the image is stopped temporarily while the display view point is moved in the dragging direction. In addition, the display apparatus 100 may also display a ‘pause’ object 71-3 indicating that the panorama image is stopped temporarily.

The embodiment described above is merely an example, and an example embodiment is not limited thereto. Various user interactions such as touch length, touch frequency, touch intensity, or two or more touches simultaneously sensed are possible. In addition, the reproduction speed corresponding to each user interaction may be set in various ways. For example, if a user interaction that touches and then drags twice rather than a user interaction that touches and drags once is input, the panorama image may be displayed more slowly while the display view point is moved, or if a user interaction of touching and dragging with greater pressure is input, the panorama image may be displayed in a slow manner while the display view point is moved.

In the above description, the user interaction is received using a touch screen provided on the display apparatus 100. However, even when the user interaction is input by the remote controller, the reproduction speed of the panorama image may be controlled in various ways while the display view point is moved according to various user interactions such as the time, the number of times, the intensity of pressing button, and the number of button pressed, etc.

As described above, by controlling the reproduction speed of the panorama image variously while moving the display time according to various user interactions, the user can enjoy the panorama image more conveniently.

Meanwhile, FIG. 8 is a diagram illustrating various example embodiments in which the reproduction of a panorama image displayed in a display apparatus is controlled according to a user interaction.

Referring to FIG. 8, when a user interaction is input, the display apparatus 100 may display a menu 81 for converting the reproduction state of the panorama image. Specifically, if a user interaction is input, the display apparatus 100 may display the menu 81 for converting the reproduction state of the panorama image according to a user selection in a pop-up form.

In this case, the menu 81 for converting the reproduction state of the panorama image may include items such as ‘play’, ‘pause’, ‘fast’, and ‘slow.’

The display apparatus 100 may receive one of the items displayed on the menu 81 from a user and covert the panorama image to be in a reproduction state corresponding to the selected item. Here, if no selection is received from the user for a predetermined time, the display apparatus 100 may convert the panorama image to a predetermined state or maintain the current reproduction state. Meanwhile, the items included in the menu 81 for converting the reproduction state of the panorama image is not limited, and may include various reproduction speeds.

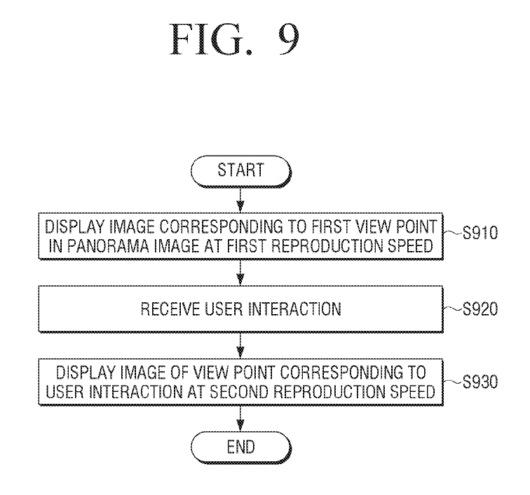

FIG. 9 is a flowchart illustrating an example method of controlling a display apparatus according to an example embodiment.

A display apparatus may display an image corresponding to a first view point in a panorama image (S910). Specifically, a first reproduction speed may be 1× speed which is a normal reproduction speed.

Subsequently, the display apparatus may receive a user interaction (S920). Specifically, the display apparatus may receive a user interaction through a touch screen provided in the display apparatus itself or a remote controller which is a separate electronic device. In this case, the display apparatus may receive a user interaction to move a display view point in the panorama image.

The display apparatus may display an image corresponding to the user interaction at a second reproduction speed (S930). Specifically, when a user interaction to move the display view point from the first view point to the second view point in the panorama image is input, the display apparatus may display images corresponding to each view point between the first view point and the second view point at the second reproduction speed while the display view point is moved. In this case, the second reproduction speed may be a pause with the reproduction speed of 0 or the second reproduction speed that is slower than the first reproduction speed.

In other words, if a user interaction is input, the display apparatus may stop the panorama image temporarily or display the panorama image slowly while the display view point is moved, and may also display an object indicating that the display view point is moved. Meanwhile, the display apparatus may output sound indicating that the display view point is moved while the display view point is moved.

According to the above-described various example embodiments, by changing the reproduction speed of the panorama image and moving the display view point as a user interaction is input, a user can enjoy various screens in the panorama image at a time zone or close to the time when the user interaction is input without missing any.

Meanwhile, the above-described various example embodiments may be implemented in a recording medium readable by a computer or a similar device using software, hardware, or a combination thereof. According to a hardware implementation, the embodiments described in this disclosure may be implemented using at least one of a dedicated processor, a CPU, application specific integrated circuits (ASICs), digital signal processors (DSPs), digital signal processing devices (DSPDs), programmable logic devices (PLDs), field programmable gate arrays (FPGAs), a processor, controllers, micro-controllers, microprocessors, and an electrical unit for performing other functions. In some cases, the embodiments described herein may be implemented by processor 130 itself. According to a software implementation, embodiments such as the procedures and functions described herein may be implemented with separate software modules. Each of the software modules may perform one or more of the functions and operations described herein.

The method of controlling a display apparatus according to the above-described various example embodiments may be stored in a non-transitory readable medium. Such a non-transitory readable medium may be mounted and used in various devices.

The non-transitory computer readable medium is readable by an apparatus. Specifically, programs for performing the above-described various methods can be stored in a non-transitory computer readable medium such as a CD, a DVD, a hard disk, a Blu-ray disk, universal serial bus (USB), a memory card, ROM, or the like, and can be provided.

The foregoing example embodiments and advantages are merely examples and are not to be construed as limiting the example embodiments. The present teaching can be readily applied to other types of apparatuses. Also, the description of the example embodiments of the present disclosure is intended to be illustrative, and not to limit the scope of the claims.

What is claimed is:

1. A display apparatus, comprising:
a display configured to display an image corresponding to a first view point in a panorama image at a predetermined first reproduction speed,
an input unit comprising circuitry configured to receive a user interaction for moving a display view point of the panorama image; and
a processor configured to control the display to display an image of a view point corresponding to the received user interaction by changing the reproduction speed of the panorama image to a second reproduction speed.

2. The apparatus as claimed in claim 1, wherein the processor, in response to the user interaction being completed, is configured to control the display to display the image of the second view point which is currently displayed at the first reproduction speed.

3. The apparatus as claimed in claim 1, wherein the processor, in response to the user interaction being completed, is configured to control the display to display a frame at the first reproduction speed from a frame of the panorama image immediately before changing to the second reproduction speed.

4. The apparatus as claimed in claim 1, wherein the second reproduction speed is one of: a pause and a reproduction speed which is slower than the first reproduction speed.

5. The apparatus as claimed in claim 1, wherein the processor is configured to control the display to display the panorama image at a second reproduction speed corresponding to a type of the received user interaction.

6. The apparatus as claimed in claim 1, wherein the processor, in response to a reproduction speed of the panorama image being changed, is configured to control the display to display information at the changed reproduction speed.

7. The apparatus as claimed in claim 1, wherein the processor, in response to the user interaction input being received, is configured to control the display to display a menu for changing a reproduction state of the panorama image.

8. The apparatus as claimed in claim 1, further comprising:
an audio output unit comprising audio output circuitry configured to output an audio signal corresponding to the panorama image,
wherein the processor, in response to a reproduction speed of the panorama image being changed, is configured to control the audio output unit to output a predetermined sound or to control the audio output unit to output an audio signal corresponding to the changed reproduction speed.

9. The apparatus as claimed in claim 1, wherein the processor is configured to control the display to display UI information corresponding to a view point which is currently displayed.

10. The apparatus as claimed in claim 1, wherein the panorama image is a panorama image having a view of 360°.

11. A method of controlling a display apparatus, comprising:
displaying an image corresponding to a first view point in a panorama image at a predetermined first reproduction speed,
receiving a user interaction for moving a display view point of the panorama image; and
displaying an image of a view point corresponding to the received user interaction by changing the reproduction speed of the panorama image to a second reproduction speed.

12. The method as claimed in claim 1, further comprising:
in response to the user interaction being completed, displaying the image of the second view point which is currently displayed at the first reproduction speed.

13. The method as claimed in claim 11, further comprising:
in response to the user interaction being completed, displaying a frame at the first reproduction speed from a frame of the panorama image immediately before changing to the second reproduction speed.

14. The method as claimed in claim 11, wherein the second reproduction speed is one of: a pause and a reproduction speed which is slower than the first reproduction speed.

15. The method as claimed in claim 11, wherein the displaying an image of a view point corresponding to the received user interaction comprises displaying the panorama image at a second reproduction speed corresponding to a type of the received user interaction.

16. The method as claimed in claim 11, further comprising:
in response to a reproduction speed of the panorama image being changed, displaying information at the changed reproduction speed.

17. The method as claimed in claim 11, further comprising:
in response to receiving the user interaction, displaying a menu for changing a reproduction state of the panorama image.

18. The method as claimed in claim 11, further comprising:
in response to a reproduction speed of the panorama image being changed, outputting a predetermined sound or outputting an audio signal corresponding to the changed reproduction speed.

19. The method as claimed in claim 11, further comprising:
displaying UI information corresponding to a view point which is currently displayed.

20. A non-transitory computer readable recording medium including a program which, when executed by a processor, causes a display apparatus to perform operations comprising:
displaying an image corresponding to a first view point in a panorama image at a predetermined first reproduction speed,
receiving a user interaction for moving a display view point of the panorama image; and
displaying an image of a view point corresponding to the received user interaction by changing the reproduction speed of the panorama image to a second reproduction speed.
